(19) United States
(12) Patent Application Publication
(10) Pub. No.: US 2024/0035506 A1
(43) Pub. Date: Feb. 1, 2024

(54) ATTACHMENT SYSTEM FOR ATTACHING TWO PARTS TO ONE ANOTHER BY REVERSIBLE SNAP-FITTING

(71) Applicant: LATELEC, TOULOUSE (FR)

(72) Inventor: DAREN THOMAS, WESTON SUPER MARE (GB)

(21) Appl. No.: 18/019,443

(22) PCT Filed: Jul. 27, 2021
(86) PCT No.: PCT/EP2021/071048

§ 371 Date: Feb. 2, 2023

(30) Foreign Application Priority Data
Aug. 3, 2020 (FR) FR2008239

(51) Int. Cl. F16B 21/08; F16B 21/06

(52) U.S. Cl. CPC F16B 21/086; F16B 21/065

(57) ABSTRACT

An attachment system to attach two parts to one another. The system includes a first part having a resiliently deformable hook and a second part includes a housing. The hook configured to be engaged in the housing so as to co-operate therewith by a reversible snap-fitting to mechanically bond the first and second parts together. The attachment system further includes a locking element which can be moved between a locking position, in which it opposes any deformation of the hook that would allow the hook to leave the housing, and a release position, in which it enables a deformation of the hook to allow the hook to leave the housing.

### FIELD OF THE INVENTION

The present invention belongs to the field of attachment devices or systems. Especially, the invention relates to an attachment system by reversible resilient snap-fitting of two parts to one another.

The present invention finds particularly advantageous application in the field of aeronautics.

### STATE OF THE ART

Attachment systems for attaching two parts to one another, especially in the field of aeronautics, generally consist of assembly techniques that are well known from the state of the art.

Among usual assembly techniques, mention can be made of screw-nut systems, such as bolts, adhesive layers and other bonding techniques, rivets, etc.

These assembly techniques are generally tedious and complex to implement on large parts.

Furthermore, assembly operations may require a high level of technical expertise or know-how for their implementation.

These restrictions are hardly compatible with the assembly of parts to be carried out in very short lapses of time, for example in large-scale production, especially in the aeronautical field.

Another drawback of some of the attachment systems of the state of the art lies in the fact that they are definitive, that is, non-reversible, especially attachment systems implementing bonding or riveting.

There is therefore a need for an attachment system for attaching two parts to one another that is easy and quick to implement in order to respond favourably to the constraints of large-scale production, while enabling the reversibility of the assembly produced.

### SUMMARY AND OBJECT OF THE INVENTION

One purpose of the present invention is to remedy all or part of the drawbacks of prior art, especially those set out above, by providing an attachment system for attaching two parts to one another.

The system comprises a first part including a resiliently deformable hook and a second part comprising a housing, the hook being capable of being engaged in the housing so as to cooperate with the latter by reversible resilient snap-fitting to mechanically bond the first and second parts together.

By the terms “mechanically bond”, it is meant that the first and second parts are attached to one another without degrees of freedom.

The attachment system further advantageously includes a locking element movable between a locking position in which it forbids any deformation of the hook sufficient to enable its removal from the housing, and a release position in which it allows a deformation of the hook sufficient to enable its removal from the housing.

Thus, the assembly of the first and second parts to one another can be achieved quickly and simply.

Furthermore, the invention enables the assembly to be locked.

In particular embodiments, the invention may further include one or more of the following features, taken alone or in any technically possible combination.

In particular embodiments, the locking element is resiliently deformable, and its locking position corresponds to a rest position and its release position corresponds to a stressed position, that is, a position in which the locking element is biased.

This feature helps to increase the reliability of the attachment system and to ensure the security of the locking of the assembly of the first and second parts to one another.

In particular embodiments, the housing includes a transverse cavity into which the locking element is adapted to move to occupy its release position.

By this arrangement, the attachment system is relatively compact. In particular embodiments, the housing extends between a first opening for insertion of the hook and a second opening opposite to said first opening, the locking element extending so as to be able to be biased to occupy its release position from the second opening.

Advantageously, this feature enables unsecuring of the two parts of the attachment system to be simplified.

In particular embodiments, the locking element is formed by a tab extending into the housing so as to be adjacent to the hook when it cooperates by resilient snap-fitting with the housing.

Thus, the locking element is simple in design and inexpensive to produce, which helps to reduce the overall cost of the attachment system according to the invention.

In particular embodiments, the tab has a free end bent towards the cavity, the cross section of said tab being convex in a direction opposite to the cavity.

This feature is advantageous in that it enables the tab to be easily biased with an elongated tool, for example in the shape of a rod. In other words, this particular shape of the tab enables the hooks to be easily released.

In particular embodiments, the first part includes at least one pair of resiliently deformable hooks, the hooks of a pair of hooks being parallel and comprising lugs oriented in opposite directions to one another, the locking element being interposed between said hooks of a pair of hooks when engaged in the housing. Each pair of hooks is intended to be engaged in an associated housing. In other words, there are as many pairs of hooks as there are housings. The attachment system includes one locking element per pair of hooks.

These features increase the mechanical strength of the first and second parts when they cooperate by resilient snap-fitting, that is, when they are mechanically bonded together.

In particular embodiments, the first and second parts include respectively male and female members of complementary shapes, cooperating with each other when the first and second parts are mechanically bonded together.

These features further increase the mechanical strength of the first and second parts when they cooperate by resilient snap-fitting, that is, when they are mechanically bonded together.

In particular embodiments, the male member of the first part takes the form of a rib arranged to extend between two adjacent pairs of hooks, and the female member of the second part takes the form of a cavity of complementary shape to the rib, said cavity being arranged to extend between two adjacent housings.

In particular embodiments, the male member is formed by a pin or pins and the female member is formed by a hole or holes corresponding in shape to that of the pin or pins, the or each pin extending from the first part respectively in a direction parallel to that in which the hooks extend and the or each hole extending in a direction parallel to that in which the housings extend.

According to a second aspect, the present invention relates to a method for unsecuring two parts of an attachment system as previously described, implemented by the following successive steps:
deforming the locking element to its release position,
deforming the hook so that it no longer cooperates with the housing by resilient snap-fitting,
removing the hook from the housing.

### BRIEF DESCRIPTION OF THE FIGURES

The invention will be better understood upon reading the following description, which is given purely by way of non-limiting example, and is made with reference to the figures which represent:

FIG. 1 is a perspective view of an attachment system according to the invention comprising a first and a second part, and a detail view of said attachment system,

FIG. 2 is a phantom perspective view of the second part of FIG. 1,

FIG. 3 is a detail perspective view of the first part assembled with the second part,

FIG. 4 is a cutaway top view of the detail view of FIG. 3,

FIG. 5 is a perspective view of another example of the second part of FIG. 1.

In these figures, identical references from one figure to another denote identical or similar elements. For reasons of clarity, the elements represented are not necessarily to the same scale, unless otherwise stated.

It should be now noted that the figures are not to scale.

### DETAILED DESCRIPTION OF AN EMBODIMENT OF THE INVENTION

The present description is given by way of non-limitation, each feature of one embodiment can advantageously be combined with any other feature of any other embodiment.

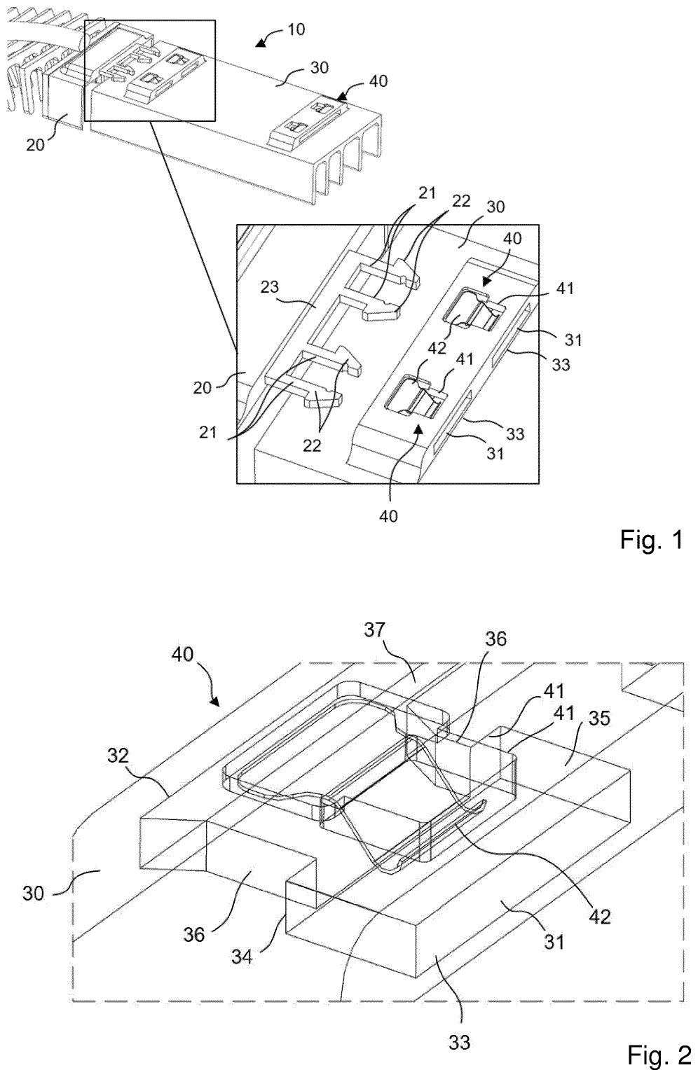

The present invention relates to an attachment system 10 for attaching two parts to one another by reversible resilient snap-fitting, an exemplary embodiment of which is represented in FIGS. 1 to 4.

As represented in FIG. 1, the attachment system 10 according to the invention comprises a first part 20 comprising a resiliently deformable hook 21 and a second part 30 comprising a body into which a through housing 31 extends. The hook 21 is intended to be engaged in the housing 31 so as to cooperate with the latter by reversible resilient snap-fitting to mechanically bond the first and second parts 20 and 30 together, that is, to assemble the first part 20 with the second part 30.

Preferably, the first part 20 includes at least one pair of hooks 21 intended to be engaged in a housing 31. More precisely, the first part 20 includes at least one pair of hooks 21, each pair of hooks is intended to be engaged in an associated housing. In the exemplary embodiment detailed in this description and represented in FIGS. 1 to 4, the second part includes two housings 31. The first part 20 includes two pairs of parallel hooks 21, each pair being intended to be engaged in a housing 31. Preferably, each pair of hooks 21 of the first part 20 is intended to be engaged in the respective housings 31 of the second part 30 simultaneously. This feature is advantageous in that it makes it possible to distribute the mechanical stresses undergone by the system and thus to increase the mechanical strength of said system, especially with respect to torsional and bending biases.

For reasons of clarity and ease of reading, the following text specifically describes a pair of hooks 21 and a housing 31 with which it is intended to cooperate.

Obviously, this description applies to all pairs of hooks 21 and all housings 31 that the attachment system 10 may include.

As illustrated in FIGS. 1, 3 and 4, the hooks 21 of the pair respectively comprise an inner side flank opposite to an outer side flank, the inner side flanks of the hooks 21 of the same pair facing each other.

Each hook 21 has a lug 22 extending along its outer side flank to a free end of said hook 21. Thus, as shown in the detail view of FIG. 1 and FIG. 4, the lugs 22 of the hooks 21 are oriented in opposite directions to one another. Advantageously, the lugs 22 have a triangular longitudinal cross-section, decreasing to the free end of each hook 21.

Each hook 21 is resiliently deformable along an angular displacement in a plane extending perpendicularly to the inner and outer side flanks of the hooks 21.

Each housing 31 is a through housing so that it comprises a first opening 32 for insertion of the hooks 21 and a second opening 33 opposite to said first opening 32. Each housing 31 further comprises two facing side walls connecting two parallel inner walls, called “upper wall” and “lower wall”, visible especially in FIG. 2. The side walls and the upper and lower walls extend between a first end defining the first opening 32 and a second end defining the second opening 33.

When the first and second parts 20 and 30 are assembled, the side walls of the housings 31 are intended to face the outer side flanks of the hooks 21.

Advantageously, the side walls may have a bevelled shape, as represented in FIG. 2, so that the first opening 32 is flared to enable easy insertion of the hooks 21 within the housing 31. Furthermore, the side walls form shoulders 34 between the first and second openings 32 and 33, directed towards their second end. In other words, the distance between the two side walls is greater along a portion of the length of the housing 31, called the “end portion” 35, extending between the shoulders 34 and the second opening 33, than along a portion of its length, called the “insertion portion” 36, extending between the shoulders 34 and the first opening 32.

Thus, when the first and second parts 20 and 30 are moved so as to insert the hooks 21 into the housings 31, the lugs 22 first slide against the bevelled shape of the side walls, resulting in a progressive resilient deformation of the hooks 21. The hooks 21 then change from an initial rest state to a stressed state.

The hooks 21 then slide against the insertion portion 36 and retain their stressed state and deformation.

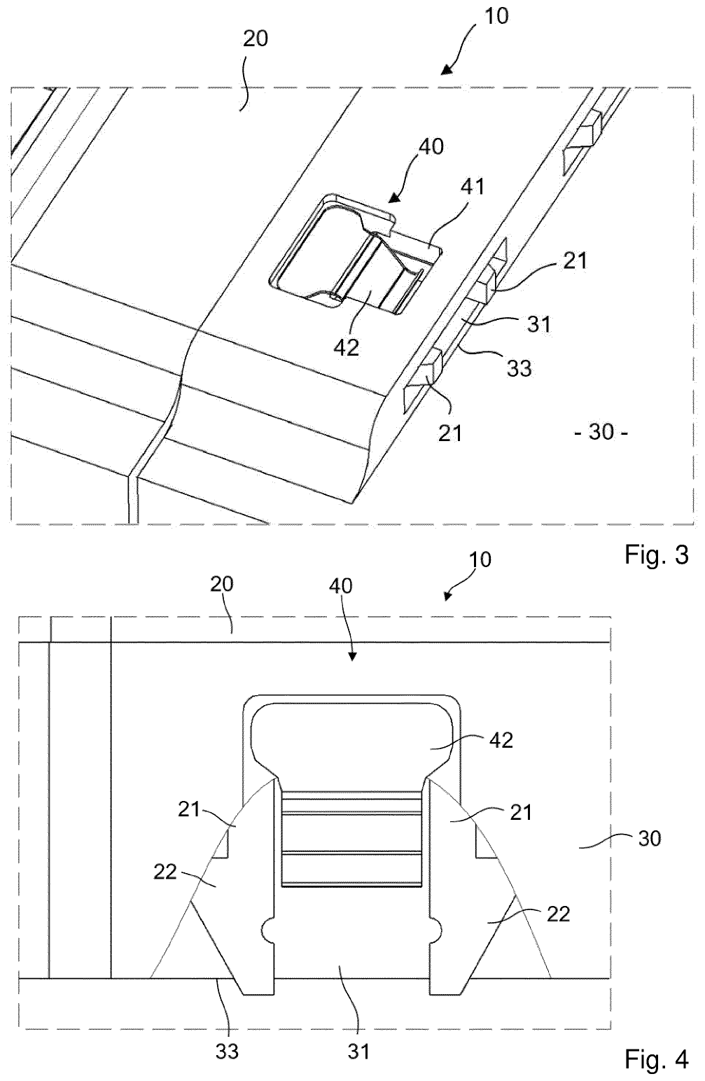

Subsequently, by a resilient return effect, the hooks 21 return to their initial rest state when the lugs 22 are arranged against the end portion 35, at the shoulders 34. In the latter position represented in FIGS. 3 and 4, called the “attachment position”, the first and second parts 20 and 30 are in abutment with each other and the lugs 22 bear against the shoulders 34, so that the first and second parts 20 and 30 are rigidly attached to one another, without any degree of freedom.

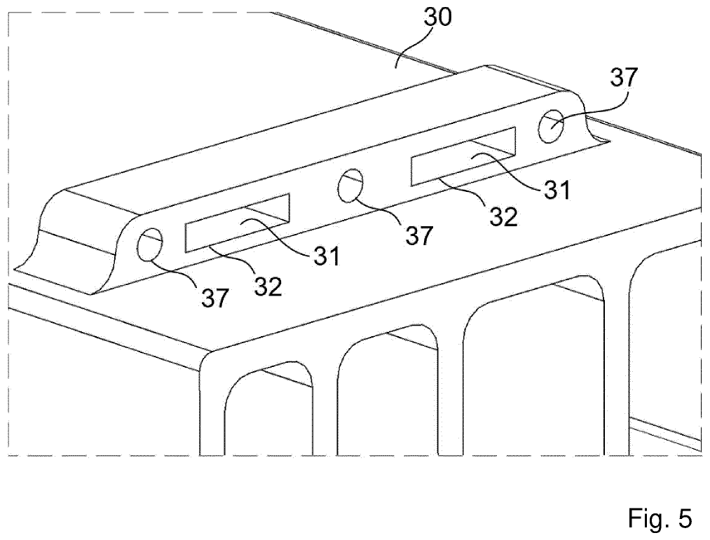

Alternatively, the shoulders 34 can be formed by the second opening 33, as represented in FIG. 5. The housings 31 then only have an insertion portion 36, and do not have an end portion 35. In this case, the lugs 22 are intended to extend outside the housing 31 when the hooks 21 are resiliently engaged with the latter.

In order to be able to remove the hooks 21 from the housings 31 and to unsecure the first and second parts 20 and 30 from one another, it is necessary to move the hooks 21 so as to disengage the lugs 22 from the shoulders 34, that is, to resiliently deform the hooks 21 so as to bring them closer together.

Advantageously, the attachment system 10 includes a locking element 40 configured so as to occupy a locking position in which it forbids any deformation of each of the hooks 21 when the latter are engaged within the housing 31, and a release position in which it allows the movement, that is, the resilient deformation, of said hooks 21.

Thus, the locking element 40 makes it possible to maintain the bond between the first and second parts 20 and 30, that is, the assembly of said parts together, by forbidding the disengagement of the lugs 22 from the shoulders 34 so as to enable the removal of the hooks 21 from said housing 31.

The locking element 40 is preferably resiliently deformable, its locking position corresponding to a rest position and its release position corresponding to a stressed position, that is, a position in which it is subjected to a force.

In the exemplary embodiment represented by the figures, the housing 31 includes a transverse cavity 41 in which the locking element 40 is adapted to move to occupy its release position. In other words, the cavity 41 is configured to receive the locking element 40 when it occupies its release position. More precisely, the cavity 41 extends through all or part of a thickness of one of the inner walls, for example the upper wall as illustrated in FIG. 2 or 3.

For ease of manufacture, the cavity 41 may be open-ended, as illustrated in FIGS. 1 to 3. In other words, the cavity 41 extends through the entire thickness of one of the inner walls, for example the upper wall as illustrated in FIG. 2 or 3.

When the hooks 21 are driven so as to be engaged in the housing 31, the hooks are in a stressed state. They force the locking element 40 towards its release position, until they return to their initial rest state when the first and second parts 20 and 30 are in the attachment position, said locking element 40 then resuming its locking position by resilient return effect.

Advantageously, the locking element 40 extends so as to be able, from the second opening 33 of the housing 31, to be biased to occupy its release position. In other words, the locking element 40 is configured such that it is accessible, for example by an appropriate tool such as a long tool, from the second opening 33 of the housing 31.

Preferably, the locking element 40 is partly fixedly bonded to the second part 30.

In the particular example represented in the figures, the locking element 40 is formed by a resilient tab 42 extending into the housing 31 so as to be adjacent to the hooks 21 when the latter are engaged in the housing 31, as visible in FIGS. 3 and 4. More particularly, the tab 42 extends in length between one end, called the first end, by which it is attached to the second part 30, and a free end, and in width along a dimension substantially corresponding, apart from the mechanical clearances, to the dimension separating the two hooks 21, more precisely separating the inner side flanks of the two hooks, when they cooperate by resilient snap-fitting with the housing 31. By “extends in length” it is meant that the tab 42 has a longitudinal dimension in a direction extending between the first opening and the second opening of the housing 31.

The first end of the tab 42 is for example attached to the second part 30, in the cavity 41, at one of the edges delimiting said cavity in the thickness of the inner wall, as illustrated in FIGS. 2 and 3.

It is understood here that the tab 42 is configured so as to be deformable only in a direction transverse to the housing 31, in order to be able to allow the insertion of the hooks 21 into the housing 31 and their release.

The tab 42 is thus configured so as to withstand mechanical stresses resulting from possible biases of the hooks 21. This feature makes it possible to ensure the locking of the hooks 21 and consequently to ensure the integrity of the attachment of the first part 20 with the second part 30.

In particular, as shown in the exemplary embodiment represented in FIGS. 1 to 3, the free end of the tab 42 is bent towards the cavity 41, the cross-section of said tab 42 having a concavity facing said cavity 41. In other words, the convexity of the tab 42 is directed towards the interior of the housing 31.

These features also facilitate the insertion of the hooks 21 within the housing 31 insofar as they can slide progressively under the tab 42 as they are inserted. Similarly, it is understood that these features also facilitate the biasing of the tab 42 towards its release position.

Clearly, the attachment system 10 includes as many locking elements 40 as there are pairs of hooks 21.

Advantageously, the first and second parts 20 and 30 may include complementary shaped male and female members 23 and 37 respectively, which co-operate with each other when the first and second parts 20 and 30 are mechanically bonded together.

This feature increases the resistance to mechanical stresses, especially torsional and bending biases, to which the hooks 21 are subjected when the first and second parts 20 and 30 are assembled together.

The male member 23 of the first part 20 may take the form of a rib as represented in FIG. 1, arranged so as to extend between two pairs of adjacent hooks 21, and the female member 37 of the second part 30 may take the form of a cavity of complementary shape to the rib, as partly represented in FIG. 2, said cavity being arranged so as to extend between two adjacent housings 31.

In another exemplary embodiment of the invention, the male member 23 may be formed by a pin or pins (not represented in the figures), for example in the form of a rod of cylindrical cross-section, and the female member 37 may be formed by a hole or holes corresponding in shape to that of the pin or pins, as represented in FIG. 5. The or each pin extends from the first part respectively in a direction parallel to that in which the hooks 21 extend and the or each hole extends in a direction parallel to that in which the housings 31 extend.

More generally, it should be noted that the above implementation and embodiment have been described as non-limiting examples, and that other alternatives are therefore possible.

1-8. (canceled)

9. An attachment system to attach two parts to one another, the attachment system comprising:
a first part comprising a resiliently deformable hook;
a second part comprising a housing, the hook configured to be engaged in the housing so as to cooperate with the housing by a reversible resilient snap-fitting to mechanically bond the first and second parts together;
a locking element movable between a locking position which forbids any deformation of the hook sufficient to enable a removal of the hook from the housing, and a release position which allows a deformation of the hook sufficient to enable the removal of the hook from the housing, the locking element being resiliently deformable, the locking position corresponding to a rest position and the release position corresponding to a stressed position; and
wherein the housing comprises a transverse cavity in which the locking element is configured to move to occupy the release position.

10. The attachment system of claim 9, wherein the housing extends between a first opening for an insertion of the hook and a second opening opposite to the first opening, the locking element extending so as to be biased to occupy the release position from the second opening.

11. The attachment system of claim 9, wherein the locking element is formed by a tab extending into the housing so as to be adjacent to the hook when the tab cooperates by resilient snap-fitting with the housing.

12. The attachment system of claim 11, wherein the tab has a free end bent towards the transverse cavity, the cross section of the tab being convex in a direction opposite to the transverse cavity.

13. The attachment system of claim 9, wherein the first part comprises at least one pair of resiliently deformable hooks, each pair of resiliently deformable hooks being configured to be engaged in a respective housing, said at least one pair of hooks being parallel and comprising lugs oriented in opposite directions to one another, the locking element being interposed between hooks of said at least one pair of hooks when engaged in the respective housing.

14. The attachment system of claim 9, wherein the first and second parts comprise respectively male and female members of complementary shapes, co-operating with each other when the first and second parts are mechanically bonded together.

15. The attachment system of claim 13, wherein the first and second parts respectively comprise a male member and a female member of complementary shapes, co-operating with each other when the first and second parts are mechanically bonded together.

16. The attachment system of claim 15, wherein the male member of the first part takes a form of a rib arranged to extend between two adjacent pairs of hooks, and wherein the female member of the second part takes a form of a cavity of complementary shape to the rib, the cavity of the complementary shape to the rib being arranged to extend between two adjacent housings.

17. The attachment system of claim 14, wherein the male member is formed by at least one pin and the female member is formed by at least one hole corresponding in shape to that of said at least one pin, said at least one pin extending from the first part respectively in a direction parallel to that in which the hooks extend and said at least one hole extending in a direction parallel to that in which the housings extend.
